(19) United States
(12) Patent Application Publication
(10) Pub. No.: US 2015/0026714 A1
(43) Pub. Date: Jan. 22, 2015

(54) SYSTEMS AND METHODS OF SHARING VIDEO EXPERIENCES

(71) Applicants: Han-Shen Yuan, Sunnyvale, CA (US); Marc Peter Hosein, Saratoga, CA (US)

(72) Inventors: Han-Shen Yuan, Sunnyvale, CA (US); Marc Peter Hosein, Saratoga, CA (US)

(73) Assignee: eBay Inc., San Jose, CA (US)

(21) Appl. No.: 13/946,818

(22) Filed: Jul. 19, 2013

(51) Int. Cl. H04N 21/214; H04N 21/24; H04N 21/436; H04N 21/81; H04N 21/414

(52) U.S. Cl. CPC H04N 21/214; H04N 21/812; H04N 21/41407; H04N 21/436; H04N 21/2408
USPC 725/32; 725/78

(57) ABSTRACT

A system and method of sharing video experiences are described. A request may be received from a first device to view video content being captured by a second device. The first device may be enabled to display the video content being captured by the second device based on a determination that the first device is capturing or has captured video content. Enabling the first device to display the video content being captured by the second device may comprise streaming live video content being captured by the second device as the live video content is being captured by the second device. Enabling of the first device to display the video content captured by the second device may be further based on a determination that the first device is located within a geo-fence.

### TECHNICAL FIELD

The present application relates generally to the technical field of data processing, and, in various embodiments, to systems and methods of sharing video experiences.

### BACKGROUND

Viewers of a live event are typically limited in their ability to view the event from different angles or points of view while attending the event. The ability of the host of the event to provide a supplemental view to each viewer is limited by the cost and logistics of using multiple cameras, multiple camera operators, and large screen displays.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates video content being shared, in accordance with an example embodiment;

FIG. 2 is a block diagram illustrating a video sharing system, in accordance with an example embodiment;

FIG. 3 illustrates a mobile device displaying shared video content and capturing video content to be shared, in accordance with an example embodiment;

FIG. 4 illustrates a mobile device displaying advertisements, in accordance with an example embodiment;

FIG. 5 is a flowchart illustrating a method of sharing video content, in accordance with an example embodiment;

FIG. 6 is a flowchart illustrating a method of enabling a first device to display video content being captured by a second device, in accordance with an example embodiment;

FIG. 7 is a flowchart illustrating another method of enabling a first device to display video content being captured by a second device, in accordance with an example embodiment; and

FIG. 8 shows a diagrammatic representation of a machine in the example form of a computer system within which a set of instructions may be executed to cause the machine to perform any one or more of the methodologies discussed herein, in accordance with an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of sharing video experiences. Crowdsourcing may be employed to provide a user with alternative views of an event from other users watching the same event. A user may capture video content of the event using a device having video capture capabilities. In some embodiments, this device may be a mobile device. Such mobile devices may include, but are not limited to, smart phones and tablet computers. The user may share this captured video content with other users so that they are able to view the captured video content on their devices. The user may also view video content captured by the other users on his or her device. In some embodiments, the captured video content may be streamed live from one user device to another so that one user may view the video content being captured by the device of the other user as the video content is being captured, and vice-versa, thereby providing the users with alternative perspectives of an event in real-time as the events are taking place. A user device's ability to access and view video content captured by another user device may be conditioned upon the user device capturing and sharing video content, thereby requiring the user to contribute captured video content if he or she wants to view the captured video content of other users. Furthermore, a user's ability to participate in this sharing of video experiences may be conditioned upon the user's device being located within a particular area defined by a geo-fence.

In some embodiments, a system comprises a machine and a video sharing module on the machine. The machine may have a memory and at least one processor. The video sharing module may be configured to receive a request from a first device to view video content being captured by a second device, and to enable the first device to display the video content being captured by the second device based on a determination that the first device is capturing or has captured video content.

In some embodiments, enabling the first device to display the video content being captured by the second device may comprise streaming live video content being captured by the second device as the live video content is being captured by the second device. In some embodiments, the enabling of the first device to display the video content captured by the second device may be further based on a determination that the first device is located within a geo-fence. In some embodiments, the video sharing module may be further configured to enable the second device to display the video content being captured by the first device based on a determination that the second device is capturing or has captured video content. In some embodiments, enabling the first device to display the video content being captured by the second device may comprise transmitting source information of the video content being captured by the second device to the first device, the source information being configured to enable the first device to establish a connection with the second device for receiving the video content being captured by the second device. In some embodiments, enabling the first device to display the video content being captured by the second device may comprise receiving the video content being captured by the second device, and transmitting the received video content to the first device. In some embodiments, the first device may be a mobile device and the second device may be a mobile device. In some embodiments, the video sharing module is further configured to cause an advertisement to be displayed on the first device.

In some embodiments, a computer-implemented method may comprise receiving a request from a first device to view video content being captured by a second device, and enabling, by a machine having a memory and at least one processor, the first device to display the video content being captured by the second device based on a determination that the first device is capturing or has captured video content.

In some embodiments, enabling the first device to display the video content being captured by the second device may comprise streaming live video content being captured by the second device as the live video content is being captured by the second device. In some embodiments, the second device may be located within a geo-fence, and the enabling of the first device to display the video content captured by the second device may be further based on a determination that the first device is located within the geo-fence. In some embodiments, the method may further comprise enabling the second device to display the video content being captured by the first device based on a determination that the second device is capturing or has captured video content. In some embodiments, enabling the first device to display the video content being captured by the second device may comprise an intermediation server transmitting source information of the video content being captured by the second device to the first device. The source information may be configured to enable the first device to establish a connection with the second device for receiving the video content being captured by the second device. In some embodiments, enabling the first device to display the video content being captured by the second device may comprise an intermediation server receiving the video content being captured by the second device, and the intermediation server transmitting the received video content to the first device. In some embodiments, the first device may be a mobile device and the second device may be a mobile device. In some embodiments, the method further comprises causing an advertisement to be displayed on the first device.

In some embodiments, a non-transitory machine-readable storage device may store a set of instructions that, when executed by at least one processor, causes the at least one processor to perform the operations or method steps discussed within the present disclosure.

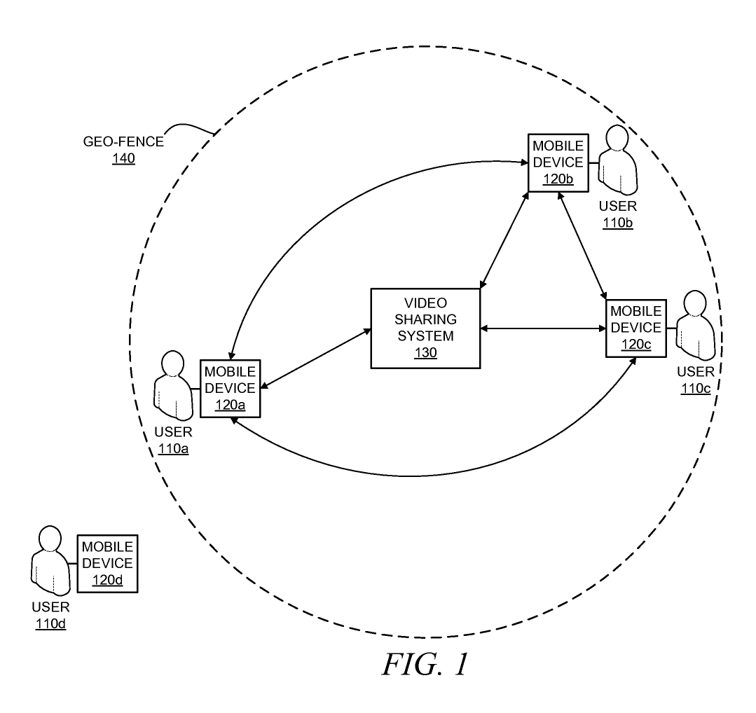

FIG. 1 illustrates how video content may be shared, in accordance with an example embodiment. As previously mentioned, users 110a-110c may capture video content of an event using their respective mobile devices 120a-120c, which may having video capture capabilities. Such mobile devices may include, but are not limited to, smart phones and tablet computers, which may have built-in camcorders. Each user may share the video content captured by his or her respective device with other users so that the other users are able to view the captured video content on their devices. Each user may also view video content captured by the other users on his or her device. For example, user 110a may capture video content using mobile device 120a and share the captured video content with users 110b and 110c on their respective mobile devices 120b and 120c, user 110b may capture video content using mobile device 120b and share the captured video content with users 110a and 110c on their respective mobile devices 120a and 120c, and user 110c may capture video content using mobile device 120c and share the captured video content with users 110a and 110b on their respective mobile devices 120a and 120b. In some embodiments, the captured video content may be streamed live from one user device to another so that one user may view the video content being captured by the device of the other user as the video content is being captured, and vice-versa, thereby providing the users 120a-120c with alternative perspectives of an event in real-time as the events are taking place.

The ability of a mobile device to access video content captured by another user device may be conditioned upon the mobile device capturing and sharing video content, thereby requiring the user of the mobile device to contribute captured video content if he or she wants to view the captured video content of other users. In some embodiments, a user's mobile device may be required to be currently capturing video content in order for the user's mobile device to access and display video content captured by a mobile device of another user. In some embodiments, a first mobile device may only be allowed to view the video content captured by another mobile device while the first mobile device is capturing video content. For example, in some embodiments, the mobile device 110a of user 110a may be restricted from accessing and displaying video content captured by the mobile device 110b of user 110b until mobile device 110a starts capturing video content, and the ability of mobile device 110a to access and display this video content may be terminated in response to mobile device 110a terminating its capturing of video content. Such a restriction ensures that a user must contribute to the shared video experience in order to benefit from the shared video experience.

In some embodiments, a user's mobile device may not be required to be currently capturing video content in order to access and display video content captured by a mobile device of another user. In some embodiments, such access and display may be enabled based on the mobile device (or another mobile device registered to the same user) having previously captured and shared video content. It may be required that the mobile device (or another mobile device registered to the same user) has captured a predetermined amount of video content (which may be measured by duration or data size of the video content) in order for the mobile device to be enabled to access and display the video content captured by another mobile device. It may be required that the mobile device (or another mobile device registered to the same user) has captured video content within a predetermined time constraint (e.g., within the last month).

Furthermore, in some embodiments, a user's ability to participate in this sharing of video experiences may be conditioned upon the user's device being located within a particular area. In some embodiments, this particular area may comprise an arena, a stadium, or a theater. However, it is contemplated that other areas are also within the scope of the present disclosure. Referring to FIG. 1, the area may be defined by a geo-fence 140. It may be determined whether or not a mobile device is located within the geo-fence 140 using Global Positioning System (GPS) technology, Wi-Fi technology, or other location determination techniques for devices. If a mobile device is not determined to be within the geo-fence 140, then the mobile device may be prevented from participating in the sharing and accessing of captured video content. For example, in FIG. 1, user 110d and his or her mobile device 120d may be located outside of the geo-fence 140. As a result, mobile device 120d may be restricted from, or otherwise unable to, access and display video content captured by any of mobile devices 110a-110c.

It is contemplated that the sharing and accessing of captured video content may be achieved in a variety of ways. In some embodiments, a video sharing system 130 may be employed to manage the sharing and accessing of captured video content. In some embodiments, the video sharing system 130 may comprise a peer-to-peer intermediation server that is configured to implement a streaming video platform. The video sharing system 130 may be configured to receive a request from one of the mobile devices 120a-120c to view video content being captured by one or more of the other mobile devices 120a-120c. The video sharing system 130 may be configured to enable the mobile device that made the request to display the video content being captured by the other mobile device(s) based on a determination that the requesting mobile device is capturing or has captured video content.

It is contemplated that this enabling of the mobile device to display the video content may be achieved in a variety of ways. In some embodiments, the video sharing system 130 may enable the mobile device to display the video content being captured by the other mobile device(s) by transmitting source information of the requested video content. The source information may be configured to enable the mobile device requesting the video content to establish a connection with the other mobile device(s) for receiving the video content being captured by the other mobile device(s). In some embodiments, the video sharing system 130 may enable the requesting mobile device to display the video content being captured by the other mobile device(s) by receiving the video content being captured by the other mobile device(s), and transmitting the received video content to the requesting mobile device. Communication amongst the mobile devices 120a-120c and the components of the video sharing system 130 may be achieved via a variety of telecommunication and networking technologies, including, but not limited to, the Internet and Wi-Fi technologies. It is contemplated that other communication methodologies are also within the scope of the present disclosure.

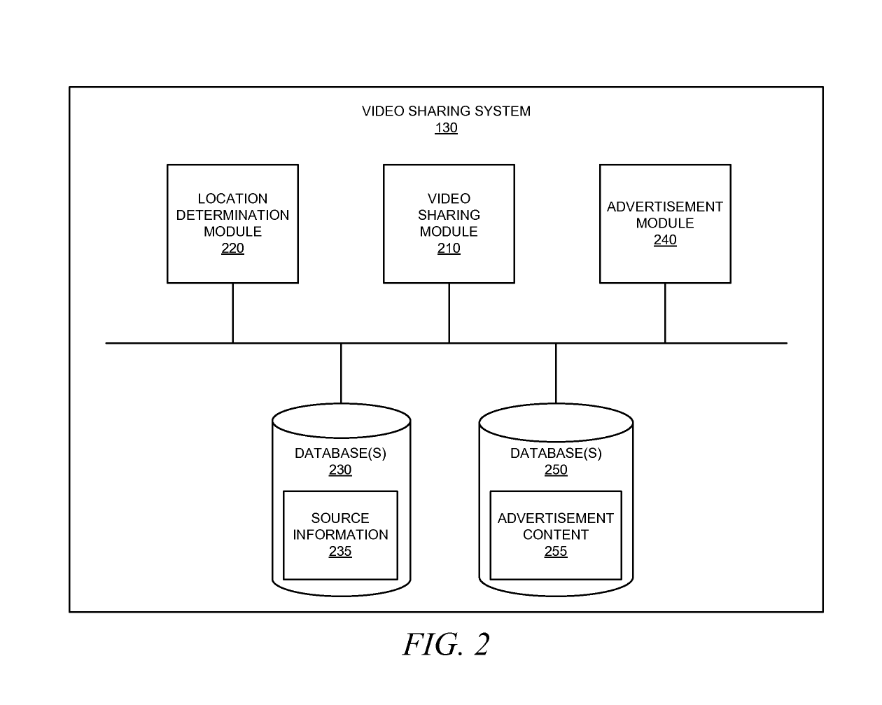

FIG. 2 is a block diagram illustrating a video sharing system 130, in accordance with an example embodiment. In some embodiments, the video sharing system 130 may comprise a video sharing module 210 on a machine. The machine may have a memory and at least one processor (not shown). The video sharing module 210 may be configured to receive a request from a first device to view video content being captured by a second device, and to enable the first device to display the video content being captured by the second device based on a determination that the first device is capturing or has captured video content, as previously discussed. In some embodiments, the video sharing module 210 may be configured to stream live video content being captured by the second device as the live video content is being captured by the second device.

In some embodiments, the enabling, by the video sharing module 210, of the first device to display the video content captured by the second device may be further based on a determination that the first device is located within a geo-fence 140. In some embodiments, the video sharing system 130 may comprise a location determination module 220 configured to determine whether devices are within the geo-fence 140.

In some embodiments, the video sharing module 210 may be configured to enable the first device to display the video content being captured by the second device by transmitting source information 235 of the video content being captured by the second device to the first device. The source information 235 may be configured to enable the first device to establish a connection with the second device for receiving the video content being captured by the second device. Here, the captured video content may be transmitted from the second device to the first device without having to pass through the video sharing module 210 or any other part of the video sharing system 130. In some embodiments, the source information 235 may be stored as part of an index on one or more databases 230.

In some embodiments, the video sharing module 210 may be configured to enable the first device to display the video content being captured by the second device by receiving the video content being captured by the second device, and transmitting the received video content to the first device. Here, the video sharing module 210 may relay the captured video content from the second device to the first device.

In some embodiments, the video sharing module 210 may be further configured to cause one or more advertisements to be displayed on the first device. The advertisement(s) may be caused to be displayed on the first device in response to the first device participating or requesting to participate in the shared video experience disclosed herein. For example, the advertisement(s) may be caused to be displayed on the first device in response to the first device capturing and sharing video content, or in response to the first device displaying captured video content from the second device, or in response to the first device requesting to access video content, or in response to a mobile application being run on the first device. The advertisement(s) may be formed from advertisement content 255 stored on one or more databases 250. An advertisement module 240 may be configured to determine and retrieve advertisement content 255 based on one or more factors. Such factors may include, but are not limited to, location, time, date, identification of the first device, identification of the user of the first device, and identification of an event being captured. The video sharing module 210 may then cause the determined advertisement content 255 to be displayed on the first device.

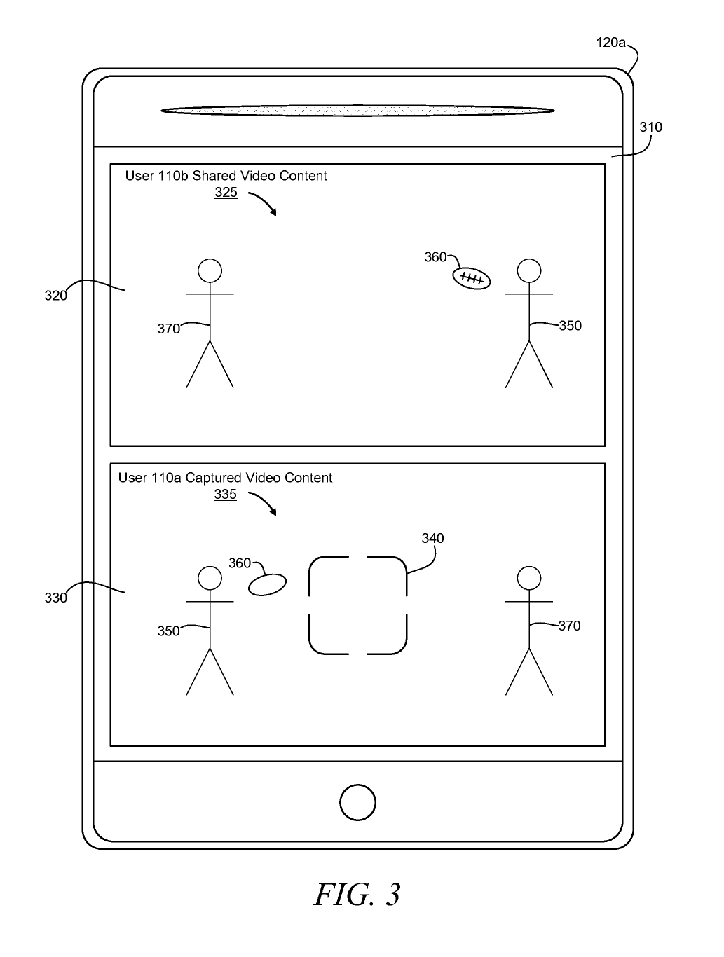

FIG. 3 illustrates a mobile device 120a displaying shared video content 325 and capturing video content 335 to be shared, in accordance with an example embodiment. The mobile device 120a may comprise a display screen 310 configured to display graphics (e.g., video). The shared video content 325 from another mobile device, such as the mobile device 120b of user 110b, may be displayed in a first display area 320 of the display screen 310. The shared video content 325 may comprise captured video content of an event. For example, user 110b may be capturing video content from a football game where a first player 350 is throwing a football 360 to a second player 370. User 110a may view this video content, which has been captured from the perspective of user 110b, in the first display area 320 on his or her mobile phone 120a.

User 110a may also use mobile phone 120a to capture video content of the same event, but from a different angle. For example, user 110a may use a camcorder feature on mobile phone 120a to capture video content of the event. User 110a may use a second display area 330 on the display screen 310 to capture the video content. Focus marks 340 may be used to help the user 110 focus the camcorder. As seen in FIG. 3, user 110a may capture video content of the event from an opposite side as user 110b. The captured video content 335 of user 110a may then be shared with other users, such as user 110b.

Although FIG. 3 shows the second display area 330 with captured video content 335 of user 110a being the same size as the display area 320 with captured video content 325 of user 110b, it is contemplated that other configurations are also within the scope of the present disclosure. For example, the second display area 330 for user 110a to capture video content may be much smaller than the first display area 320 for displaying the video content of user 110b in order to provide more room for the video content 325 of user 110b. In some embodiments, the second display area 330 with the video content 335 of user 110a may be completely removed, thereby maximizing the amount of room available on the display screen 310 for video content captured by other users.

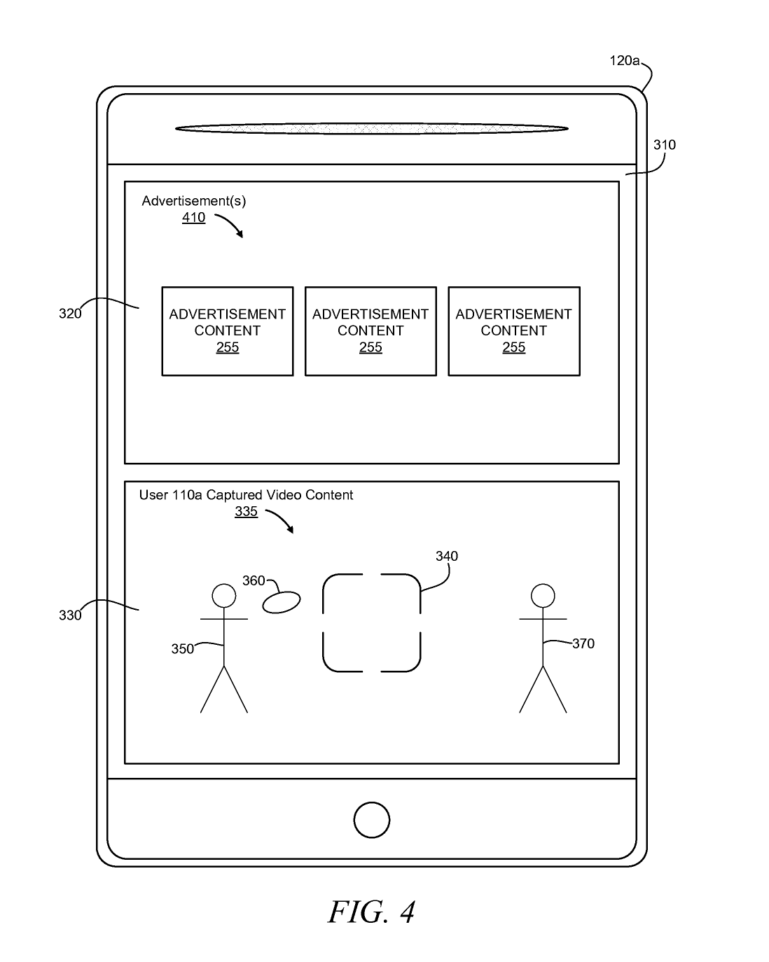

FIG. 4 illustrates a mobile device 120a displaying advertisements 410, in accordance with an example embodiment. Here, the advertisements 410 are formed by advertisement content 255, which may be displayed in the first display area 320 of the display screen. The advertisements 410 may be displayed for a predetermined amount of time. In some embodiments, the advertisements 410 may be displayed before, during, or after the captured video content of the other user is displayed. Although not shown, in some embodiments, one or more advertisements 410 may be displayed on the display screen 310 at the same time as the captured video content of the other user. It is contemplated that other display configurations are also within the scope of the present disclosure.

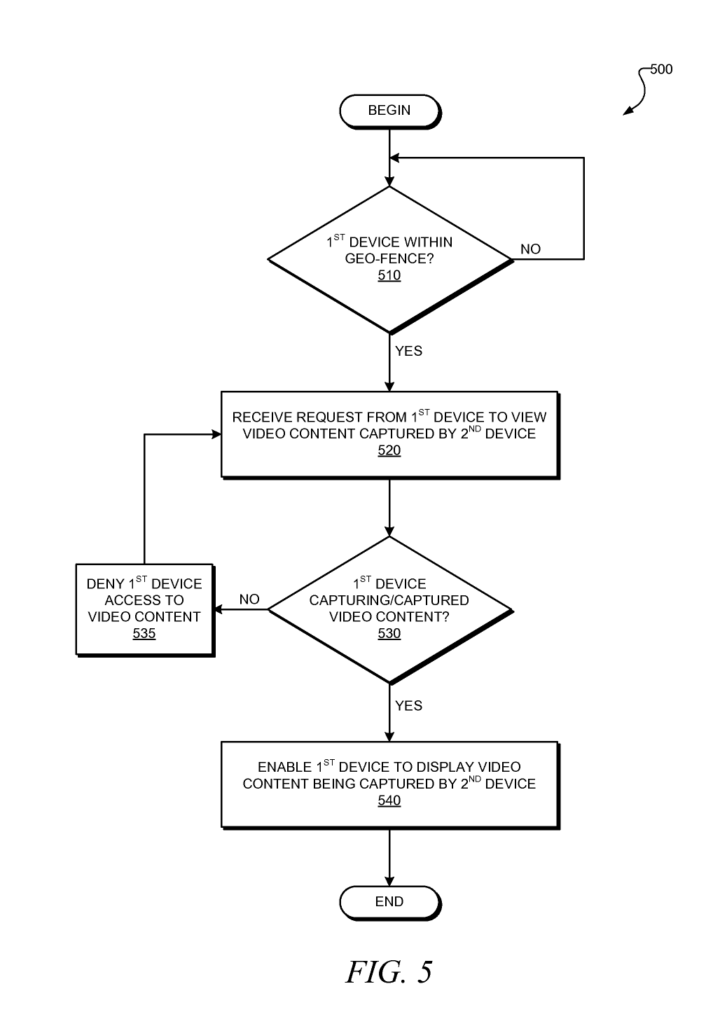

FIG. 5 is a flowchart illustrating a method 500 of sharing video content, in accordance with an example embodiment. It is contemplated that the operations of method 500 may be performed by a system or modules of a system (e.g., video sharing system 130 in FIGS. 1-2). It is contemplated that the operations of method 500 may also be performed by a mobile application on a mobile device. At operation 510, it may be determined whether or not a first device is within a geo-fence. If it is determined that the first device is not within the geo-fence, then the method 500 may repeat this operation until a determination is made that the first device is within the geo-fence. If it is determined that the first device is within the geo-fence, then, at operation 520, a request to view video content captured by a second device may be received from the first device. At operation 530, it may be determined whether or not the first device is capturing or has captured video content. If it is determined that the first device is not capturing or has not captured video content, then, at operation 535, the first device may be denied access to the requested video content. The first device may be notified that it is being denied access based on its lack of capturing video content so that the user of the first device may correct this deficiency by capturing video content. The method may then repeat at operation 520. If, at operation 530, it is determined that the first device is capturing or has captured video content, then, at operation 540, the first device may be enabled to display video content being captured by the second device. It is contemplated that any of the other features described within the present disclosure may be incorporated into method 500.

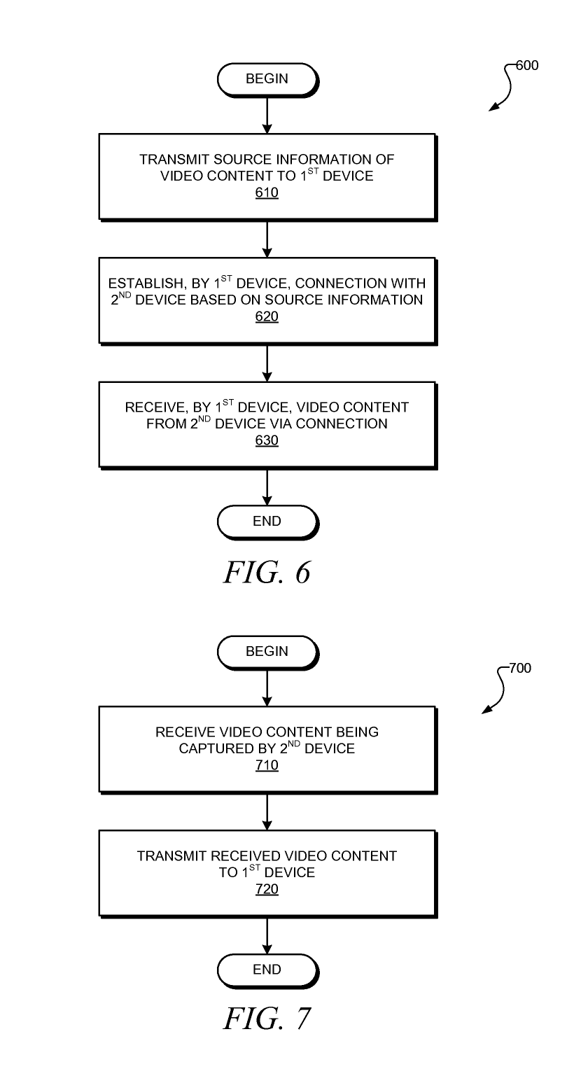

FIG. 6 is a flowchart illustrating a method 600 of enabling a first device to display video content being captured by a second device, in accordance with an example embodiment. It is contemplated that the operations of method 600 may be performed by a system or modules of a system (e.g., video sharing system 130 in FIGS. 1-2). It is contemplated that the operations of method 600 may also be performed by a mobile application on a mobile device. At operation 610, source information of video content may be transmitted to a first device. At operation 620, the first device may establish a connection with a second device based on the source information. At operation 630, the first device may receive video content from the second device via the established connection. It is contemplated that any of the other features described within the present disclosure may be incorporated into method 600.

FIG. 7 is a flowchart illustrating another method 700 of enabling a first device to display video content being captured by a second device, in accordance with an example embodiment. It is contemplated that the operations of method 700 may be performed by a system or modules of a system (e.g., video sharing system 130 in FIGS. 1-2). At operation 710, video content being captured by a second device may be received. At operation 720, the received video content may be transmitted to a first device. It is contemplated that any of the other features described within the present disclosure may be incorporated into method 700.

The functions and operations disclosed herein may be implemented in a variety of ways. In some embodiments, users may participate in the shared video experience using a mobile application installed on the user's mobile device. In some embodiments, the mobile application may perform the functions disclosed herein. In some embodiments, a system (e.g., video sharing system 130) separate from the user's mobile device may perform the functions disclosed herein.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

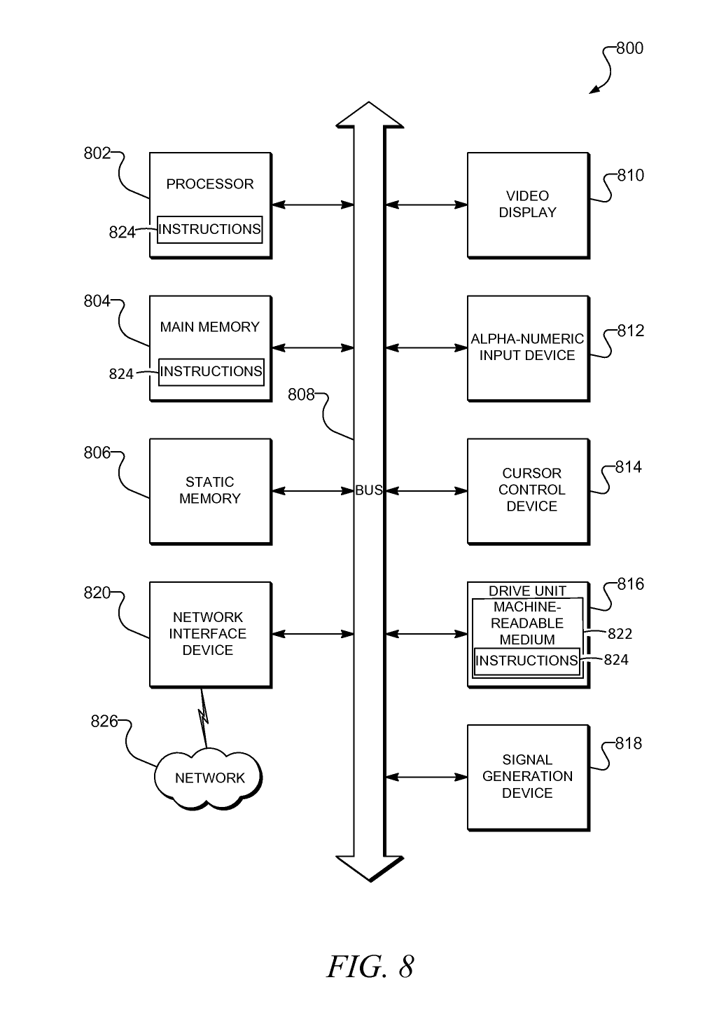

FIG. 8 is a block diagram of a machine in the example form of a computer system 800 within which instructions for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a machine having a memory and at least one processor; and
a video sharing module, executable by the machine, configured to:
receive a request from a first device to view video content being captured by a second device; and
enable the first device to display the video content being captured by the second device based on a determination that the first device is capturing or has captured video content.

2. The system of claim 1, wherein enabling the first device to display the video content being captured by the second device comprises streaming live video content being captured by the second device as the live video content is being captured by the second device.

3. The system of claim 1, wherein the enabling of the first device to display the video content captured by the second device is further based on a determination that the first device is located within a geo-fence.

4. The system of claim 1, wherein the video sharing module is further configured to enable the second device to display the video content being captured by the first device based on a determination that the second device is capturing or has captured video content.

5. The system of claim 1, wherein enabling the first device to display the video content being captured by the second device comprises transmitting source information of the video content being captured by the second device to the first device, the source information being configured to enable the first device to establish a connection with the second device for receiving the video content being captured by the second device.

6. The system of claim 1, wherein enabling the first device to display the video content being captured by the second device comprises:
receiving the video content being captured by the second device; and
transmitting the received video content to the first device.

7. The system of claim 1, wherein the first device is a mobile device and the second device is a mobile device.

8. A computer-implemented method comprising:
receiving a request from a first device to view video content being captured by a second device; and
enabling, by a machine having a memory and at least one processor, the first device to display the video content being captured by the second device based on a determination that the first device is capturing or has captured video content.

9. The method of claim 8, wherein enabling the first device to display the video content being captured by the second device comprises streaming live video content being captured by the second device as the live video content is being captured by the second device.

10. The method of claim 8, wherein the second device is located within a geo-fence, and the enabling of the first device to display the video content captured by the second device is further based on a determination that the first device is located within the geo-fence.

11. The method of claim 8, further comprising enabling the second device to display the video content being captured by the first device based on a determination that the second device is capturing or has captured video content.

12. The method of claim 8, wherein enabling the first device to display the video content being captured by the second device comprises an intermediation server transmitting source information of the video content being captured by the second device to the first device, the source information being configured to enable the first device to establish a connection with the second device for receiving the video content being captured by the second device.

13. The method of claim 8, wherein enabling the first device to display the video content being captured by the second device comprises:
an intermediation server receiving the video content being captured by the second device; and
the intermediation server transmitting the received video content to the first device.

14. The method of claim 8, wherein the first device is a mobile device and the second device is a mobile device.

15. The method of claim 8, further comprising causing an advertisement to be displayed on the first device.

16. A non-transitory machine-readable storage device storing a set of instructions that, when executed by at least one processor, causes the at least one processor to perform a set of operations comprising:
receiving a request from a first device to view video content being captured by a second device; and
enabling the first device to display the video content being captured by the second device based on a determination that the first device is capturing or has captured video content.

17. The device of claim 16, wherein enabling the first device to display the video content being captured by the second device comprises streaming live video content being captured by the second device as the live video content is being captured by the second device.

18. The device of claim 16, wherein the second device is located within a geo-fence, and the enabling of the first device to display the video content captured by the second device is further based on a determination that the first device is located within the geo-fence.

19. The device of claim 16, further comprising enabling the second device to display the video content being captured by the first device based on a determination that the second device is capturing or has captured video content.

20. The device of claim 16, wherein enabling the first device to display the video content being captured by the second device comprises an intermediation server transmitting source information of the video content being captured by the second device to the first device, the source information being configured to enable the first device to establish a connection with the second device for receiving the video content being captured by the second device.
